(19) United States
(12) Patent Application Publication
(10) Pub. No.: US 2014/0185805 A1
(43) Pub. Date: Jul. 3, 2014

(54) Securely Exchanging Cipher Keys

(71) Applicant: NEUROPACE, INC., Mountain View, CA (US)

(72) Inventor: Dean P. Andersen, San Jose, CA (US)

(73) Assignee: NEUROPACE, INC., Mountain View, CA (US)

(21) Appl. No.: 13/804,721

(22) Filed: Mar. 14, 2013

Related U.S. Application Data
(60) Provisional application No. 61/748,639, filed on Jan. 3, 2013.

(51) Int. Cl. H04W 12/04

(52) U.S. Cl. CPC H04W 12/04
USPC 380/270

(57) ABSTRACT

Methods and systems for securely exchanging cipher keys between an implantable device and an external device are described. An example method includes: receiving an authorization request from the external device, wherein the authorization request is a request to receive a first cipher key of a cipher key exchange; receiving an indication that a magnet is detected relative to the implantable device, wherein the indication signifies a secure environment for communication between the implantable device and the external device; and after receiving the authorization request and the indication of a detected magnet, generating a first cipher key transmittal instruction, wherein the first cipher key transmittal instruction instructs the first cipher key to be transmitted to the external device by the implantable device.

### CROSS REFERENCE TO RELATED APPLICATIONS

This application claims priority to and benefit of co-pending U.S. Patent Application No. 61/748,639 filed on Jan. 3, 2013 entitled “Securely Exchanging Cipher Keys” by Dean P. Andersen, assigned to the assignee of the present application, and is hereby incorporated by reference in its entirety herein.

### BACKGROUND

The methods and systems described herein relate to the field of cryptography as applied to the communication between implanted medical devices and one or more external components. More specifically, the methods and systems relate to data exchange session authentication between an implanted device and an external component.

Long-range (wireless) telemetry is an emerging form of communication between implantable devices (e.g., implantable medical devices) and programmers (i.e., a form of an external device often used by a patient's treating physician to communicate with (such as to program) an implanted medical device) and monitors (i.e., a form of an external device typically provided to a patient so that the patient can communicate in some limited fashion with his or her implanted medical device). In long-range (also known as “far field” telemetry), communication can take place over several meters or even across rooms. The patient may or may not realize or be provided with feedback as to whether long-range telemetry is occurring in a given application. Under the circumstances of long-range telemetry then, concerns arise about security and protection against unauthorized or otherwise unintended communication between the implant and an external source. For example, the risk that an implanted medical device may be hacked into using an unauthorized external source may be an issue in certain applications of implanted medical devices, especially “active” medical devices that are configured to do something once they are implanted, such as deliver a pacing pulse for the heart, deliver a form of therapy intended to modulate the behavior of neurons (e.g., electrical stimulation or a drug). Alternatively or additionally, there may be a perceived risk that a single external device may be able to communicate with (e.gl, reprogram) multiple implanted medical devices if the patients are within communication range of the external device (e.g., multiple patients with the same type of active implanted medical devices are gathered in a doctor's waiting room or in a specialized clinic, and when the doctor programs one patient's implant, the doctor inadvertently programs the implants of the patients in the waiting room as well). Even where long-range telemetry is an available means of communication between an implanted medical device and one or more external components such as one or more physician programmers, it would be desirable to mitigate these risks or perceived risks when a particular implanted medical device is communicating with a particular external device.

### BRIEF DESCRIPTION OF THE DRAWINGS

The accompanying drawings, which are incorporated in and form a part of this specification, illustrate and serve to explain the principles of embodiments in conjunction with the description. Unless specifically noted, the drawings referred to in this description should be understood as not being drawn to scale.

FIG. 1 is a block diagram illustrating an implantable device in an intended use environment, implanted in a patient.

FIG. 2 is a schematic illustration of a patient manipulating an external magnet relative to the site at which an implantable medical device has been implanted, in accordance with an embodiment.

FIG. 3 is a schematic illustration of the position of an external magnet after the manipulation indicated in FIG. 2 has occurred.

FIG. 4 is a block diagram of an implantable neurostimulator which may be used with embodiments.

FIG. 5A and FIG. 5B are a diagram illustrating a method for securely exchanging cipher keys between an implantable medical device and a programmer, in accordance with embodiments.

FIG. 6 is a flow diagram of elements of a method for securely exchanging cipher keys between an implantable device and an external device, in accordance with an embodiment.

FIG. 7 is a flow diagram of elements of a method for securely exchanging cipher keys between an implantable device and an external device, in accordance with an embodiment.

### DESCRIPTION OF EMBODIMENTS

Various embodiments are described below, with reference to detailed illustrative embodiments, in the context of implantable devices (e.g., an implantable neurostimulator). It will be apparent that the methods and systems described herein can be embodied in a wide variety of forms. Consequently, the specific structural and functional details disclosed herein are representative and do not limit the scope of embodiments.

Example methods and systems for securely exchanging a cipher key between an implantable device and an external device are described herein. Presently, at least two types of concerns have been raised relating to the need for security in wireless communication, that of privacy and integrity. Privacy is the idea that any sensitive information being passed between a medical device implanted in a patient to an external device (e.g., patient-identifiable or patient-specific information) needs to be protected so that only certain external devices are authorized to receive from or transmit information to the implant. Integrity is the idea that an implanted medical device needs to be protected so that it is not overly vulnerable to being compromised, either inadvertently or intentionally, by an external source that is not supposed to be able to communicate with it. For active medical devices especially, maintaining integrity of an implant may include protecting the implant from unwanted changes to its programming that might cause it to do something it is not intended to do or do something it is intended to do but at a different time or for longer or shorter than it is intended to do it. The embodiments described herein primarily relate to protecting the integrity of implanted medical devices against undesirable interference from unauthorized external sources.

Due to concerns regarding wireless communication security, a secure method, through cipher key establishment, for ensuring that only authorized devices can communicate with and program an implantable neurostimulator is desired. Cipher key establishment is an agreement between two entities for shared cipher keys for use in a cryptographic algorithm. A secure channel is considered to be a communication channel that is incapable of being tampered with.

The ground work for ultimately achieving such a tamper-free secure channel may be laid in a controlled environment, such as when an active implantable medical device system is being manufactured. For example, when the implantable and external components of a given implantable medical device system are being manufactured, a cryptographic key generator may be used to generate a unique key or keys (each of which key is similar to a serial number). The key(s) may be programmed into the memory of the implantable component (for example, into the non-volatile memory of a neurostimulator). Configuring the implantable component to have one or more unique cipher keys may be accomplished during manufacturing without using any external component to communicate with the implantable component (such as via telemetry). In other words, the one or more unique cipher keys may constitute factory settings for the implant. However, in some situations, setting the unique cipher keys during manufacture has limitations. For example, there is a possibility that a cipher key determined at manufacture and assigned to a particular neurostimulator may be compromised (e.g., an employee responsible for programming the neurostimulator releases to an unauthorized third party the cipher key that is assigned to the neurostimulator), thus creating security/integrity issues. Thus, it may be helpful, in some circumstances, for the neurostimulator to independently develop its own unique cipher keys, while external to its manufacturing stage. Additionally, and as will be addressed herein, setting at manufacturing time the unique cipher key for each and every external device with which the implantable component may communicate may become unwieldy and too burdensome.

It further may be helpful if, at the time a communications channel is established between an implanted medical device and an external device (e.g., a physician's programmer), it is necessarily obvious to the patient, the physician (or other caregiver) or both that this is what is going on. In other words, if the method of initiating the communication between the implant and the external device(s) is obvious, then it is less likely that one with malicious intent could establish the communication without being exposed or detected. For example, when the implantable medical device system is a neurostimulation system, one implantable component is a neurostimulator which is configured to communicate with one or more external components such as one or more physician programmers and a single patient remote monitor. Once communication is established between the implant and one of these external devices, one of the forms of communication that might take place is an interrogation of the implant. Generally, the term “interrogation” may refer to the situation where an external device requests and then receives from the implanted medical device data about the implant or which the implant has acquired from physiological sensors, such as electrodes). If the system were configured so that whenever an external device was interrogating an implant, either the patient or the physician or both would know that the interrogation was taking place, then it would be less likely that one with malicious intent would be able to get away with an authorized interrogation of the patient's implant.

Active implantable medical device systems are known that are configured so that the implant can communicate with one or more external devices via some form of inductive telemetry, for example, short range (or near field) or long range or far field telemetry. For example, an active implantable medical device system may be configured so that a programmer can reprogram an implanted medical device (e.g., to change its factory set default programming to make the programming more specific to the particular patient and his or her condition) via inductive telemetry. In addition, and depending on the capabilities of the active implant, an active implantable medical device system may be configured so that a programmer or the patient's remote monitor can interrogate the implant to obtain data obtained by or about the implant using inductive telemetry. For short range telemetry, establishing the communications link usually requires a component with a transceiver, commonly referred to as a wand. Long range telemetry systems generally avoid the requirement of a wand.

Inductive telemetry also is used in methods intended to maintain integrity between the implant and the external device or devices that are attempting to communicate with the implant. For example, in some such methods cipher keys are passed between the implant (e.g., an implanted neurostimulator) and the external device or devices (e.g., a programmer and/or a remote monitor). These methods involve using some form of encryption to ensure that only authorized external devices are able to communicate, in one direction or the other, with the implant. In addition to encryption, some methods have a feature that effectively jams attempts to communicate with the implant from an unauthorized external source, such as external sources attempting to communicate with the implants over long distances. As the development and communication/exchange of cipher keys uses much needed implant resources, it would be helpful to have a way for determining a secure environment without relying on the exchange of cipher keys between the implant and the external device. According to embodiments, a method is described that enables an up-close-and-personal magnet to initiate an exchange of cipher keys between the implant and the external device in order to open a line of communication.

Encryption methods implemented via telemetry can involve sophisticated protocols. While these protocols may provide some assurance that the integrity of the implantable medical device system will not be compromised, either inadvertently or intentionally, implementing these protocols often is costly to the system designer in terms of system complexity (e.g., elaborate algorithms) and/or power consumption (e.g., computational complexity typically translates to increased consumption of whatever power resources are available). To the extent a given protocol requires complexity and power consumption on the implanted device side, the protocols may be disfavored, since the added complexity and power consumption to establish a secure communications link may have the consequence of limiting the intended use of the active implant (e.g., delivering responsive neurostimulation therapy to a patient when the patient experiences symptoms associated with a neurological condition, such as epilepsy). In other words, system designers do not want to forego using an implant to its full potential to provide a particular therapy or other function because the implant needs a lot of computing power just to establish a reliable communications link with the outside world.

In addition to the level of sophistication, some communication protocols require both of the implanted component and the external component to exchange a predetermined unique cipher key. In order to accomplish this, not only must the implant be configured to transmit a unique predetermined cipher key when communication is attempted, but each of the external components which might ultimately be used to communicate with that implant must know and have some way of recognizing the implant's unique key when a communication link is attempted. The requirement that a given external device be programmed up front with all of the possible cipher keys of each and every implant with which the external device may someday be called upon to communicate may present logistical challenges. For example, it may be unwieldy to try and program every programmer that comes off the manufacturing line with each and every possible cipher key with which a set of implants (e.g., a manufacturing lot) might be programmed. Moreover, even if it were practical to inoculate each external device at the factory with each and every cipher key for each and every implantable device, integrity may be somewhat compromised as a result, since any of these external devices may be equipped to work with any of the implants. The situation may not be much improved if the programming of the external components with the various unique implant cipher keys is accomplished “in the field” after the implantable components are implanted and the external devices are assigned to patients or to doctors/hospitals. That is, and especially in the case of a programmer which normally is intended to be used with more than one implant, it still may be logistically challenging to match up each external device with the set of implants with which the external device might reasonably be expected to someday communicate. Programmers may get swapped in and out of hospitals or doctor's offices and returned for service to the manufacturer, and each time this happens, the manufacturer or a field clinical engineer likely will have to reevaluate whether the external device is able to recognize the unique cipher keys of the implants with which it is supposed to communicate.

An example of a known communication protocol that requires each of the implanted and the external components to communicate with one another functions as follows. Each active implantable medical device is provided with a unique cipher key. This key is typically between 56-256 bits. At the time that the active implant is manufactured, a cryptographic key generator running on a personal computer generates a unique key, similar to a serial number, which is programmed into the non-volatile memory of the active implantable medical device. In order to communicate with the implantable neurostimulator, any programmer would have to know the implant's cipher key, a priori. Thus, in this known method, each implantable neurostimulator has a unique cipher key that only the programmer(s) knows, and without this cipher key, the programmer cannot successfully interrogate the implantable neurostimulator. With this paradigm, getting cipher keys from the implantable neurostimulator to the programmer and/or remote monitor, or vice-versa, is the challenge.

Embodiments discussed herein describe systems and methods that enable a cipher key exchange between an active implanted medical device (such as an implanted neurostimulator) and an external device (such as a programmer and/or a remote monitor) without the external device knowing beforehand what a implant's unique cipher key is in order to open a communication pathway or link between the two devices. In other words, and unlike the case with some known communication protocols, it is not necessary with these embodiments that an external device be programmed in advance with a cipher key that matches a cipher key of an implant. A given external device need not have a priori knowledge of the cipher key for each implantable neurostimulator with which the external device ultimately might communicate.

Embodiments discussed herein also allow the authentication of an implantable neurostimulator and the external device using a magnetic field, thus establishing a secure channel, using a programmed key that is stored in the implantable neurostimulator. These embodiments do not require the use of short-range telemetry or an alternative communication channel to establish communication between the implant and an external device. Similarly, these embodiments do not require the communicating entities, e.g., the implant and the external component, to first obtain cipher keys from a central server by connecting to a secure network before the implant and the external component can begin communicating with each other (e.g., to allow the implant to be interrogated by an external programmer or an external patient remote monitor).

Other methods for securing exchanging cipher keys leverage the extensive knowledge and the accepted techniques of cipher key exchange. In general, though, the more sophisticated the cipher key exchange protocol (for communicating across unsecured channels [public-key cryptography]), also typically require very high computational resources. The reason for this is that it is desirable for one entity to strongly authenticate the other entity to ensure its validity before communication is permitted. Power is commonly at a premium insofar as implantable medical devices are concerned, and methods requiring computational complexity therefore may be disfavored.

Embodiments described herein provide for a low overhead cipher key exchange protocol while also not requiring exhaustive computational resources from the implantable medical device. These embodiments may be contrasted to other methods for providing a secure channel which require a lot of computational resources to carry out. One example of a method for providing a secure channel that requires relatively high overhead, in terms of computational resources, is the well-known key exchange protocol, Diffie-Hellman, requires high computational resources. In a Diffie-Hellman key exchange protocol, each communication session requires software running in the implanted device and in the external device to generate a random number, x. The cipher key exchange algorithm takes a random number and two parameters (G and P) to make a public key. Upon receiving the public key, both the implantable neurostimulator and the programmer have to calculate a shared (also known as secret or private) key. Depending upon the size of the parameters (the larger the number the better for security), finding the value of the exponential number for the shared key can be very computationally expensive. For example, if the public key is 8-bits, and the random number is 8-bits, a worst case exponent would be 255²⁵⁵, approximately a 200 bit number. This calculation to find the shared key can be done using multi-precision mathematics, which can be computational costly in the implantable neurostimulator. Implantable neurostimulators have a low power platform and generally do not have extensive computational capabilities.

Exponential calculations are often used in cipher key exchange protocols since these can be used to form one-way functions. One-way functions are easy to compute in one direction but difficult in other directions. For example, given two numbers, x=3 and y=6, one can compute x^{y}, or 3⁶=729 easily. However, knowing that x^{y}=729 and trying to find x and y (logₓ 729=y) is a more formidable problem. In a typical cipher key exchange, the numbers would be much larger and would be prime.

Other known cipher key exchanges based on elliptical curve cryptography (ECC) can lead to more efficient implementations but still are very computationally complex for a low power platform like an implantable neurostimulator. Alternative cipher key establishment protocols involve pairing or bonding one device to another. Bluetooth uses such a process. In this protocol, the two entities share a common link cipher key (PIN) that the user has to enter. Yet another quality of known cipher key exchanges is non-repudiation (e.g., attempts by a maliciously-minded sender to repudiate having sent a message).

Embodiments described herein facilitate the use of well-known standard encryption standards as the form of encryption, thereby enabling a secure way of choosing cryptographically secure keys. Standard encryption algorithms, such as the Data Encryption Standard (DES) and AES (Advanced Encryption Standard), are well known algorithms that are often called out in encryption standards such as FIPS (Federal Information Processing Standards) 140 and 197 series and the ISO/IEC (International Organization of Standards)/(International Electrotechnical Commission) 8372, 9797, and 9798 series of standards. These well-known encryption algorithms are understood to be robust and have proven to be effective in protecting classified information. For this reason, AES is effectively the US Government standard for data encryption.

The underlying principle of using standard encryption algorithms is that the method of encryption is public and not proprietary. Thus, each of the handling, maintaining, and generating of cipher keys (i.e., key management) are of critical importance in order for the data to remain secure. The same cipher key can be used for encrypting and decrypting (symmetric keys). Alternatively, different keys can be used (asymmetric).

As will be discussed below, prior to exchanging information with an external device, a patient with the implantable neurostimulator, a practitioner, and/or a third party want to make sure that the implantable neurostimulator is communicating with the external device within a secure environment, free of possible malicious programming attacks. In establishing that an environment is secure for this communication, the patient, practitioner, and/or third party swipes a magnet near to the implant site of the implantable device. The implantable neurostimulator senses a magnet signal. Sensing a magnet signal alerts the implantable neurostimulator that it is within a secure environment and communication with the external device may safely ensue.

In embodiments, a cipher key exchange occurs once it is determined that a secure environment exists. The cipher key exchange includes the implantable neurostimulator sending a cipher key meant for the external device to the external device, and the external device sending a cipher key meant for the implantable neurostimulator to the implantable neurostimulator. According to embodiments, this cipher key exchange process may occur only once or more than once according to instructions (e.g., real time or preprogrammed instructions). The cipher key exchange process occurs more than once through a cipher key exchange refresh operation (described below).

Since the action of the magnet swipe by the patient, doctor, or another caregiver must have occurred in close proximity to the patient having the implantable neurostimulator (such that the magnet sensor in the implantable neurostimulator is able to detect the magnet), it may be assumed either that the patient approves of the attempt to initiate communication or that the attempt is otherwise legitimate (e.g., when a magnet is used in an emergency room setting to communicate with a patient's implant (such as to disable it from delivering a therapy while an MRI is undertaken). In other words, because using a magnet to establish communication is an overt act and one that is generally easy to observe (i.e., bringing a magnet next to a patient's body), the environment may be considered secure enough to permit communication between the implantable neurostimulator and the external device. After a secure environment for communication is established, cipher keys are then securely exchanged between the implantable neurostimulator and the external device, according to embodiments. This method of securely exchanging cipher keys initiated by a magnet thus is likely to discourage or prevent malicious attempts to establish communication with the implant, for example, to reprogram it without authorization from the patient or his or her doctor.

In embodiments described herein, in exchanging the cipher keys, a patient or clinician “authorizes” the pairing of an implanted medical device, such as a neurostimulator, with an external device, such as a programmer and/or a patient remote monitor. This authorization of pairing confirms that the implanted device and the external device are permitted to communicate with each other and that such communication can proceed in what is understood to be a secure environment. (For purposes of describing embodiments herein, the term “programmer” may be used to describe a specific type of external device, usually operated by a clinician/doctor who is treating the patient, with which communication with an implant can be established. Similarly, a “remote monitor” may be used to refer to a specific type of external device, usually operated by a patient, with which communication with an implant can be established.)

For example, after an implanted neurostimulator and a programmer are authorized to communicate with each other (because the two devices are deemed to be operating in a secure environment), and the implant and the programmer have exchanged cipher keys, the programmer may communicate with the implantable neurostimulator by interrogating it. This authorization may occur at the implantable neurostimulator side since the implant contains the cipher key necessary for interrogation.

In one embodiment, the authorization can be in the form of the patient or the clinician swiping a magnet across the implantable neurostimulator as part of the “pairing” process. The implantable neurostimulator detects the magnet and, in conjunction with the programmer requesting authorization, (i.e., when a secure channel has been established.), the implant delivers its cipher key to the programmer. In one embodiment, this is the only “secure” time in which an implantable neurostimulator is able to send its cipher key to the programmer. It is considered secure since the transfer of the cipher key is likely only to happen with knowledge of the patient (or, perhaps in an emergency, only with knowledge of the patient's physician or other caregiver, such as an emergency room worker), because the transfer is dependent on the implant detecting the presence of a magnet in close proximity to it. In other embodiments, another layer of security may be imposed by providing additional conditions under which communication between an external component and the implant may be maintained once it has been established. For example, a condition may require the implant and the external device to exchange new cipher keys after a certain amount of time has elapsed since the communication was first established. An elapsed time condition may correspond to a value for a programmable parameter in the implant. Another condition may require the implant and the external device to exchange new cipher keys after a particular request has been made of the implant more than a maximum number of times (e.g., after the external device has “interrogated” the implant for data more than, say, five times).

In some embodiments, a secure time occurs upon the occurrence of conditions, according to preprogrammed and/or real-time instructions, such that a cipher key exchange between the implantable neurostimulator and the external device occurs whenever the conditions occur. For example, the implantable neurostimulator may be preprogrammed to deliver a cipher key to the programmer after a certain time period has elapsed since the previous cipher key was sent by the implantable neurostimulator to the programmer.

Thus, while in some embodiments, the delivery of a cipher key to the programmer to allow communication between the implant and the programmer occurs only once, in other embodiments, the delivery of cipher keys occurs more than once, for example, upon the occurrence of conditions preprogrammed into the implantable neurostimulator and/or real-time instructions given to the implantable neurostimulator.

The cipher key that the implantable neurostimulator sends to the programmer may be generated in a variety of ways. For example, in one embodiment, biological data may be used to generate the cipher key. In another embodiment, this cipher key is generated during the manufacture of the implantable neurostimulator and then placed into a non-volatile memory of the implantable neurostimulator or a non-volatile memory accessible by the implantable neurostimulator. These cipher keys that are preprogrammed and stored in a non-volatile memory are pre-paired (intended to be delivered to a predetermined device) to a particular external device (e.g., a programmer and/or a remote monitor). Similarly, cipher keys may also be preprogrammed and stored in a memory of a programmer and/or remote monitor, and are pre-paired to a particular implantable neurostimulator.

Additionally and significantly, standard encryption algorithms, such as the Advanced Encryption Standard (AES) (Federal Information Processing Standards (FIPS), 2001), may be used in conjunction with embodiments of the present technology. For example, once “pairing” has finished and the implantable neurostimulator has sent its cipher key to the programmer, both the implantable neurostimulator and the programmer now share a common cipher key. For AES, this key is either 128 or 256 bits and data packets are encrypted and decrypted in the same size of packets, or blocks. For the encryption process, this key is used to transform the data to be sent using various defined methods. Once the data has been transformed, it is sent. Once received, the recipient decrypts the data using its cipher key in a predefined transformation process. After transformation, the original data is recovered. The transformation process steps are defined in the AES documents and are well known.

In one embodiment, the exchange of cipher keys only happens once, that is, —before the programmer tries to interrogate an implantable neurostimulator (or otherwise tries to communicate with the implant) for the first time. After a successful cipher key exchange between the implant and the external component has been completed once, the programmer will store this cipher key in the programmer's memory (e.g., non-volatile memory) for the particular implantable neurostimulator. In one embodiment, the implantable medical devices has a plurality of different cipher keys are stored in its memory (preferably, but not limited to, non-volatile memory). Upon the “pairing” of the implant with an external component (such as may be initiated by the implant detecting the presence of a magnetic field), the implant may select one of these stored cipher keys to use in the exchange with the external component. After the implant and the external component have established communication with each other for some time period, the implantable neurostimulator could request a refresh of a key exchange. This would ensure the same cipher key would not be used with the same implant and the same external device forever.

Thus, embodiments provide at least the following advantages: a method of authenticating (verifying that an implantable neurostimulator and an external device are securely exchanging cipher keys) an implantable neurostimulator and an external device using a programmed key stored in the implantable neurostimulator, wherein this method does not require the use of short-range telemetry or an alternative communication channel; the ability to exchange cipher keys without the external device requiring a priori knowledge of a cipher key for each implantable neurostimulator; a low overhead key-exchange protocol that does not require exhaustive computational resources from the implantable neurostimulator; and a method of facilitating the use of well-known encryption standards as the form of encryption.

### Overview of Discussion

The discussion begins with a description of an example implantable device (an implantable neurostimulator) shown implanted within a patient. The discussion continues with a brief description of various components within and coupled with an example implantable neurostimulator for securely exchanging cipher keys between an implantable neurostimulator and an external device (e.g., a programmer and/or a remote monitor). The discussion then turns to a description of example systems and methods for securely exchanging cipher keys between an implantable neurostimulator and a programmer.

### Active Implantable Device with a Cipher Key Exchange Subsystem for Securely Exchanging Cipher Keys

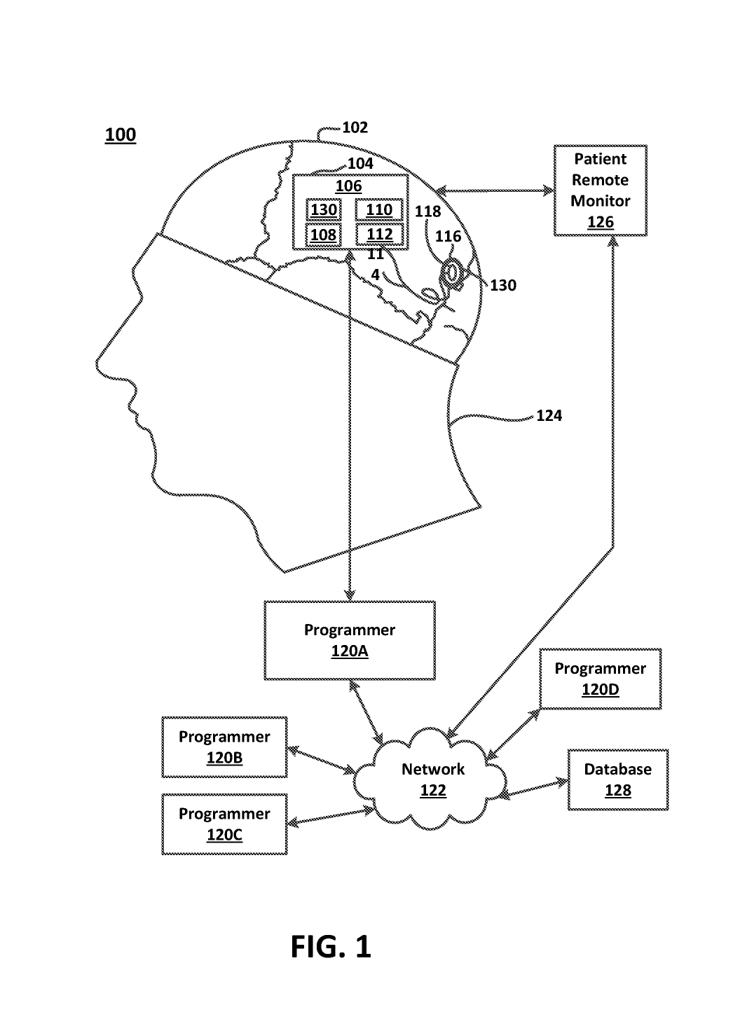

FIG. 1 illustrates an active implantable medical device. The device is an implantable neurostimulator 106 configured with a magnet sensor 130 such that the behavior of the implantable neurostimulator 106 may be affected by the presence of a magnetic field applied from an external source, such as a magnet that is supplied to the patient as part of the neurostimulation system.

The implantable neurostimulator 106 is shown implanted in a patient 124 (e.g., implanted in a ferrule which is situated during a craniotomy). The implantable neurostimulator 106 is configured to deliver a form of therapy to the patient that is intended to modulate the activity of the neural cells of the patient, such as current-controlled or voltage-controlled electrical stimulation therapy. For example, the implantable neurostimulator 106 can be placed in operable communication with one or more electrodes (an oval-shaped single electrode 118 is shown in FIG. 1). Electrodes can be configured with the implantable neurostimulator 106 in various stimulation pathways to deliver stimulation to the patient's tissue.

The implantable neurostimulator 106 may be programmed to deliver stimulation to the patient continuously or on a periodic or scheduled basis. In some cases, the implantable neurostimulator 106 may only have the capability to deliver stimulation. In other cases, the implantable neurostimulator 106 may have more complex capabilities. For example, an implantable neurostimulator configured as a responsive implantable neurostimulator may have the capacity to deliver a form of therapy when it detects a pattern of activity or other “event” in one or more channels of electrographic signals continuously monitored from the patient (e.g., using leads bearing electrodes that are implanted in or on the brain). In a responsive implantable neurostimulator, the same leads and electrodes that are used for delivering the therapy to the patient may also be used for monitoring electrographic signals from the patient.

Generally, a responsive implantable neurostimulator is configurable to sense signals from the patient corresponding to electrical activity of the brain, to continuously monitor and process the sensed signal to identify patterns or other features of the signal or patterns and/or features associated with the signal (such as, but not limited to, the date or time the signal is sensed and/or the condition of the implantable medical device at the time a pattern or other feature is detected [e.g., whether a signal amplifier is saturated and, if so, for how long]), and to identify one or more “events” in the monitored signal when certain “detection” criteria are met (e.g., meeting or exceeding fixed or dynamic thresholds [trends)]). A responsive implantable neurostimulation system is under investigation by NeuroPace, Inc. under the tradename “RNS SYSTEM”. U.S. Pat. No. 6,016,449 to Fischell et al. for “System for Treatment of Neurological Disorders” issued Jan. 18, 2000 and U.S. Pat. No. 6,810,285 to Pless et al. for “Seizure Sensing and Detection Using an Implantable Medical Device,” issued Oct. 26, 2004, also describing neurostimulation systems with responsive capabilities. U.S. Pat. Nos. 6,016,449 and 6,810,285 are incorporated by reference herein in the entirety.

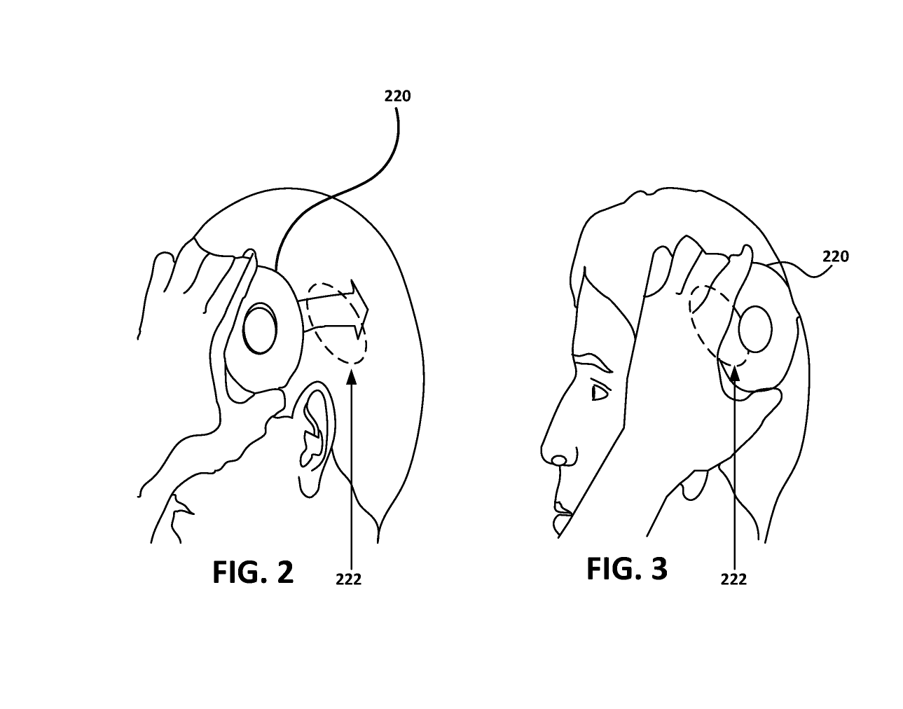

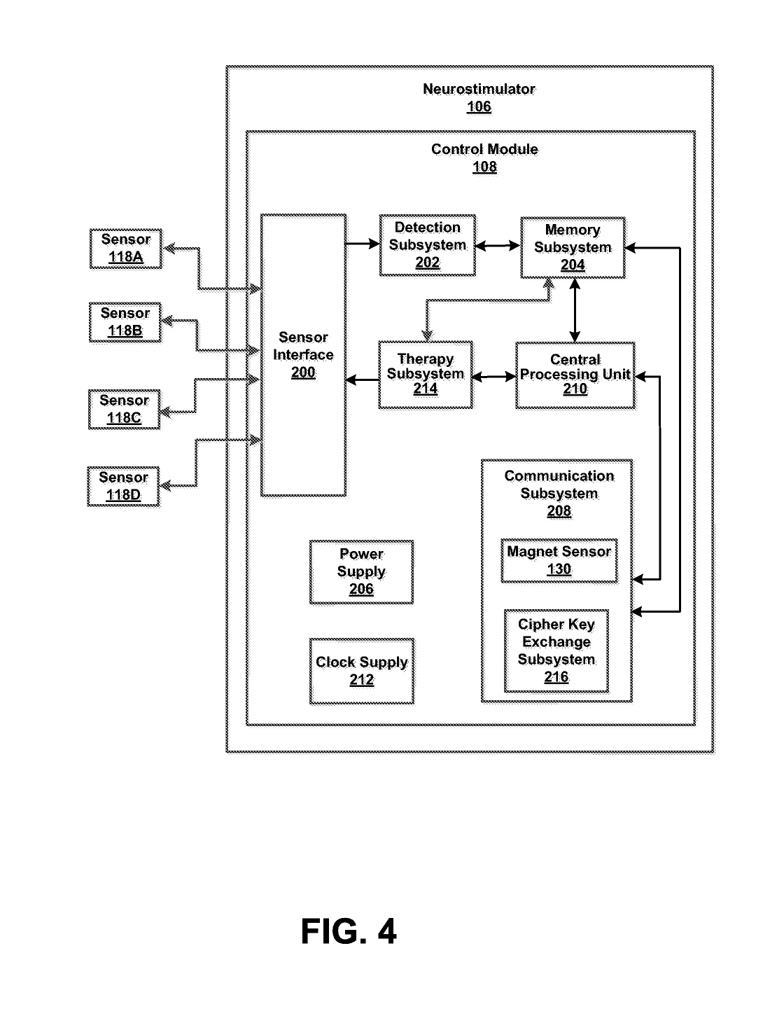

The signals sensed from the patient may be monitored by a physician or other caregiver in real time, by connecting the implanted device to an external component such as a physician's programmer that is capable of communicating with the implant wirelessly, such as via telemetry. Alternatively or additionally, the implantable neurostimulator 106 may be configured to store selected signals of the sensed signals according to certain programmed instructions. Such storage may occur periodically, whenever an event is detected, or upon command from an external component, such as a patient remote monitor 126, a physician's programmer 120A, 120B, 120C, or 120D (each of which may wirelessly communicate with the implant), or a magnet (see the magnet 220 in FIGS. 2 and 3) (the presence of which may be detected by a magnet sensor in the implant). In an application of the responsive neurostimulator 106 to diagnose and/or treat epilepsy, for example, the responsive implantable neurostimulator 106 may be configured to detect seizures and/or seizure onsets or precursors.

The implantable neurostimulator 106 records neurological signals, such as electrographic signals in the form of electroencephalographic (EEG) and electrocorticographic (ECoG) waveforms, detects and analyzes electrographic signals, and/or creates a log of such an analysis. In general, EEG signals represent aggregate electrical potentials related to neuronal activity within the brain detectable via sensors applied to a patient's scalp. ECoG signals, which are intracranial counterparts to the EEG signals, are detectable via sensors implanted over, on, or under the dura mater, and often within the patient's brain. Unless otherwise noted herein, the term “EEG” shall be used generically herein to refer to both EEG and ECoG signals.

The implantable neurostimulator 106 typically has a relatively large number and variety of parameters that can be set and subsequently be modified in a programming session after the implantable neurostimulator 106 is implanted in a patient. Thus, for example, the implantable neurostimulator 106 may be programmed to begin recording detected EEG signals satisfying certain detection parameters or criteria (e.g., based on a combination of parameter values) from the patient 124 at the onset of ictal (seizure) activity or as a result of a prediction of ictal activity. The implantable neurostimulator 106 may be configured to record signals or values corresponding or related to signals at times before, during and after the detection criteria have been met. The implantable neurostimulator 106 may continue recording until the ictal activity stops. Optionally, the implantable neurostimulator 106 saves the recording, or a sampling of it, to a memory device to preserve it for later uploading to the external device.

The implantable neurostimulator 106 may also create a log of the ictal activity. In one example, the implantable neurostimulator 106 records and/or logs the date and time when an event begins and ends, the duration of the event, indications of the intensity of the event, etc. The implantable neurostimulator 106, optionally, uploads such a log to an external device, such as, but not limited to, a programmer 120A, 120B, 120C, or 120D (described in greater detail below). The implantable neurostimulator 106 may also be configured to record and/or preserve data corresponding to EEG signals upon the initiation of some action (e.g., swiping an external magnet near the site at which the implantable neurostimulator 106 is implanted) by the patient, a caregiver or a physician.

In some embodiments, the implantable neurostimulator 106 detects and/or predicts any kind of neurological event that has a representative electrographic signature. While an embodiment is described herein as responsive to epileptic seizures, it should be recognized that the implantable neurostimulator 106 can respond to other types of neurological disorders, such as movement disorders (e.g., Parkinson's disease), migraine headaches, chronic pain and neuropsychiatric disorders (e.g., depression). In various embodiments, the implantable neurostimulator 106 detects neurological events representing any or all of these afflictions when they are actually occurring, in an onset stage, and/or as a predictive precursor before clinical symptoms begin.

Referring still to FIG. 1, the implantable neurostimulator 106 is shown as implanted in a space or volume formed in the patient's cranium by craniotomy or other neurosurgical techniques well-known in the art (the ferrule in which the implantable neurostimulator 106 is positioned is not shown). However, it should be appreciated that the placement described and illustrated herein is merely an example. Other locations and configurations are also possible, depending on the size and shape of the device and the patient's needs, among other factors.

Generally, the implantable neurostimulator 106 is positioned to follow the contours of a patient's cranium 102. However, other locations within the patient's body are also possible. For example, the implantable neurostimulator 106 may be implanted pectorally (not shown) with leads extending through the patient's neck and between the patient's cranium 102 and scalp.

With continued reference to FIG. 1, the implantable neurostimulator 106 includes a housing 104 that encapsulates electronics that allow the desired neurological signals to be detected and/or recorded and stored and the therapy (e.g., electrical stimulation therapy) to be delivered. Other implantable components of a neurostimulation system including the implantable neurostimulator 106 include electrode(s) 118 for monitoring or measuring electrographic signals and/or for delivering electrical stimulation to the patient's neural tissue. An electrode 118 may be formed from a platinum member. It will be appreciated that a neurostimulation system may include configuring an implantable neurostimulator 106 to be in operable communication with sensing or stimulation elements other than electrode(s) 118.

For example, if the application of the responsive neurostimulation system is to treat epilepsy, and a seizure focus previously has been localized for the patient, the electrodes can be implanted at locations intended to capture signals generated at or near the seizure focus. Commonly, a lead bearing electrodes (e.g., lead 114) at a distal end thereof is implanted through a hole 132 drilled in the patient's skull (usually referred to as a “burr hole” because of the cranial drill used to form it). The proximal end of the lead is then connected to the neurostimulator to put the electrodes in electrical communication with the neurostimulator. It will be appreciated that elements other than electrodes may be configured and used to sense physiological data from the patient other than electrographic signals, such as optical sensors, voltammetry sensors, oximetry probes, temperature probes, and the like.

The housing 104 may be fabricated from a biocompatible material, such as, but not limited to, titanium. Titanium is light, extremely strong and biocompatible. Other biocompatible materials may additionally or alternatively be utilized in the fabrication of the housing 104.

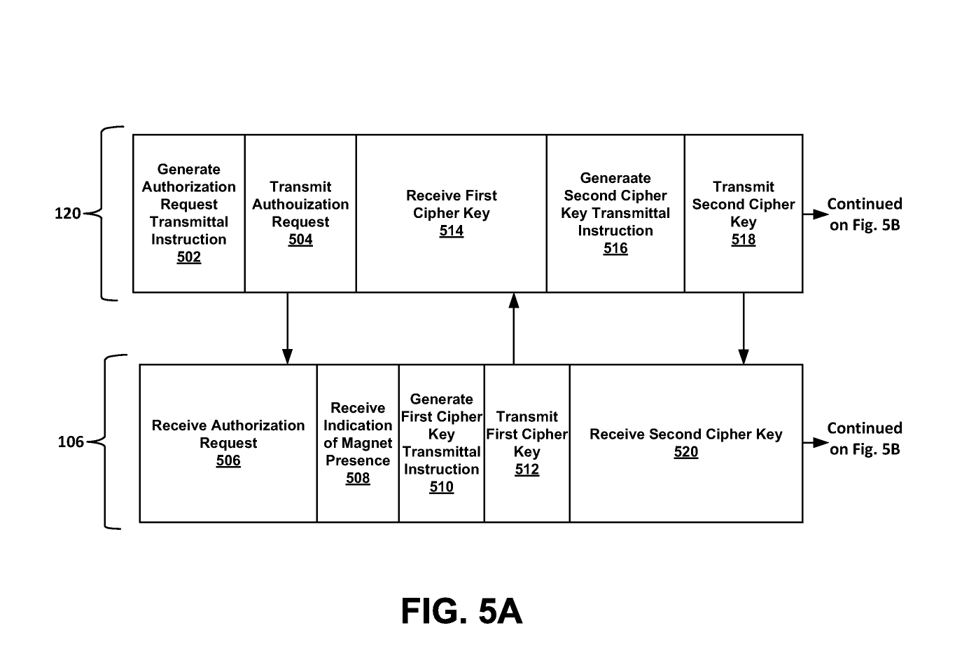

The housing 104 may also enclose a battery 110 or other source of power for the neurostimulator, as well as a physical component or components that allow the neurostimulator to perform the functions represented by the blocks in the block diagram of FIG. 4. Most of the time the implantable neurostimulator 106 will function autonomously (particularly when performing its usual sensing, detection, and recording capabilities), but the implantable neurostimulator 106 may selectively be put in communication with a programmer 120 or a patient remote monitor 126 to wirelessly transmit data from the implantable neurostimulator 106 (i.e., to interrogate the implantable neurostimulator 106 and/or monitor electrographic signals from the patient 124 in real time with an external component) or to transmit information to the implantable neurostimulator 106 (e.g., programming instructions, updates to code the neurostimulator uses to carry out its functions, etc.).

To enable wireless interrogation and delivery of new programming instructions to the implantable neurostimulator 106, a telemetry antenna (not shown) may be provided inside or outside of the housing 104. The external devices may include devices commonly referred to as “programmers” 120A, 120B, 120C, and 120D which may be laptops or tablets or other computers with which a physician can interrogate the implant and change the programming of the implant, and a patient remote monitor 126 with which the patient 124 can interact in some limited fashion with the implant, such as to interrogate the implant (so that data stored by the implant can be retrieved by the patient remote monitor 126 and subsequently uploaded elsewhere, for example, over a network 122 to a central database) elsewhere.

In some embodiments, the inductive telemetry link between the implantable neurostimulator 106 and the programmer 120 or patient remote monitor 126 may be established using a wand (not shown) by bringing the wand into the transmitting and receiving range of the implantable neurostimulator 106.

Several specific capabilities and operations performed by a programmer 120A, 120B, 120C, or 120D in conjunction with the implantable neurostimulator 106 may include, but are not limited to, the following: specifying and setting the values for parameters in the implantable neurostimulator 106 to adapt the function of the implantable neurostimulator 106 to meet the patient's needs; uploading and/or receiving data (including but not limited to EEG waveforms, logs of events detected, or data items corresponding to a condition of the implantable neurostimulator 106 [e.g., remaining useful life of battery], that are stored on the implantable neurostimulator 106); downloading and/or transmitting program code and other information; and commanding the implantable neurostimulator 106 to perform specific actions and/or change modes, as instructed by a physician operating a programmer 120A, 120B, 120C, or 120D (hereinafter, “120”, unless otherwise specifically noted). To facilitate these functions, a programmer 120 is adapted to receive physician input and provide physician output, for example, via a keypad or touch screen. Data is transmitted between a programmer 120 and the implantable neurostimulator 106 using the wireless telemetry link.

More specifically, a programmer 120 may be selectively connected with the network 122, such as the internet, via a telemetry communication link. This allows information that is uploaded from the implantable neurostimulator 106, as well as program code (or other information) intended for download to the implantable neurostimulator 106, to be stored in a database 128 at one or more data repository locations (which may include various servers and network-connected programmers). This allows the patient's physician to have access to important data, including past treatment information and software updates, essentially anywhere in the world that there is a programmer (e.g., programmer 120A) or web browser (not shown) and a network connection.

An implantable neurostimulator 106 according to embodiments has a magnet sensor 130 configured to detect a magnetic field. For example, such a magnet sensor 130 can be configured to detect the presence of a magnetic field when an external magnet is moved into the vicinity of the implantable neurostimulator 106 by the patient 124 or a caregiver. The implantable neurostimulator 106 may be configured to modify its behavior when the presence of the magnet is detected by the magnet sensor 130 as is described in more detail below.

FIG. 2 and FIG. 3 illustrate a patient's use of an external magnet to modify the behavior of an implantable neurostimulator 106 according to embodiments. The patient brings a donut-shaped magnet 220 next to a site 222 at which the implantable neurostimulator 106 (including the magnet sensor 130) has been implanted and then holds it there. The magnet sensor 130 may be incorporated inside the neurostimulator housing 104 or secured externally of the housing 104 but in selectable operation with the implantable neurostimulator 106, for example in an enclosure separate from the neurostimulator housing that is impermeable to body fluids. The magnet sensor 130 is configured to produce a signal that corresponds to whether a magnet 220 is either present or not present.

In some embodiments, the magnet sensor 130 may be configured with a circuit (e.g., in the active implantable medical device) that provides feedback to indicate whether an external magnet is in a position relative to the implant so that the magnet will have the desired effect on the implant. The circuit may cause a tone to be generated or a visual cue to be displayed to the patient (or caregiver), such as on an external device, that allows the patient to position the magnet proximate to the implant for the best interaction between the magnet and implant.

When the magnetic sensor 130 associated with the implantable neurostimulator 106 (active implantable medical device) senses the presence of a magnetic field, the implantable neurostimulator 106 may be configured to undertake different behaviors based on an indicated magnet presence and the receipt of a request from an external device (e.g., programmer 120) for authorization to communication through a secure channel, and thus, a receipt of a request for a cipher key. For example, if the clinician swipes a magnet 220 over the implantable neurostimulator 106, the magnet sensor 130 of the implantable neurostimulator 106 senses the presence of a magnetic field. If a magnetic field is sensed and a request for authorization is made by the programmer 120 to the implantable neurostimulator 106, then the implantable neurostimulator 106 sends a cipher key to the programmer 120.

FIG. 4 is a block diagram of the responsive implantable neurostimulator 106 of FIG. 1 as may be used for monitoring a signal generated by the magnet sensor 130. The magnet sensor 130 is configured so that its output corresponds to whether a magnetic field is or is not present relative to the implantable neurostimulator 106. The magnet sensor output may be binary, i.e., a signal that is either at one level or another or a bit that is either a “1” or a “0”. The implantable neurostimulator 106 may be configured so that a “high” magnet sensor output corresponds to the implantable neurostimulator 106 detecting the presence of the magnetic field and a “low” magnet sensor output corresponds to the implantable neurostimulator 106 not detecting the magnetic field. The implantable neurostimulator 106 may include algorithms and/or physical components or circuits for conditioning the output of the magnet sensor 130 to improve it before it is used to affect the behavior of the implantable neurostimulator 106. For example, the implantable neurostimulator 106 may debounce the output of the magnet sensor 130 before allowing a state change of the implantable neurostimulator 106 based on the magnet sensor 130 output to occur.

The various functions of the implantable neurostimulator 106 can be described with reference to a control module 108 that allows the implant to interface with elements for delivering a therapy to the patient 124 and with the outside world. In the responsive implantable neurostimulator 106, the control module 108 may also be configured to interface with elements for sensing physiological data (such as electrographic signals) from the patient. In some responsive implantable neurostimulators, the same elements can be used for sensing physiological data and delivering therapy. For example, in the responsive implantable neurostimulation system under investigation by NeuroPace, Inc. under the trade name “RNS SYSTEM”, the control module of the implantable neurostimulator interfaces with electrodes that are also implanted in the patient and which the implantable neurostimulator can configure either as sensing elements or as stimulation elements.

In FIG. 4, an electrode interface 200 of the control module 108 functions to select which electrodes (of the electrodes 118A, 118B, 118C, and 118D [hereinafter, “electrode 118”, unless otherwise noted]) are used by the implantable neurostimulator 106 in which configurations and for which purposes (e.g., sensing data from the patient 124 or delivering therapy to the patient 124).

The control module 108 is provided with a self-contained power supply 206 (which may be a primary cell or rechargeable battery) that supplies the voltages and currents necessary for each of the other subsystems of the implantable neurostimulator 106 to carry out its intended function(s), and a clock supply 212 which supplies needed clock and timing signals.

The control module 108 is provided with a memory subsystem 204 and a central processing unit (CPU) 210, which can take the form of a microcontroller.

The central processing unit 210 controls a therapy subsystem 214 which is configured to output a form of therapy (e.g., electrical stimulation therapy) to the patient 124, for example, via the electrode interface 200 and then one or more of the electrodes 118. (The electrode interface 200 may also encompass charge-balancing and other functions required for a proper interface with neurological tissue.)

The communication subsystem 208 allows the implantable neurostimulator 106 to communicate with the outside world. For example, the communication subsystem 208 is provided with a magnet sensor 130 and is coupled with the cipher key exchange subsystem 216 so that the implantable neurostimulator 106 can recognize and adjust its behavior based on the presence or absence of a magnetic field from a magnet applied externally of the implant (see, e.g., FIG. 2).

The communication subsystem 208, via the central processing unit 210 or otherwise, may cause the memory subsystem 204 to record and store one or more data items relative to the magnet sensor 130 and the cipher key exchange subsystem 216. In one embodiment, the communication subsystem 208 includes the cipher key exchange subsystem 216. However, in another embodiment, the communication subsystem 208 and the cipher key exchange subsystem 216 are communicatively coupled (wired or wirelessly), but independent of each other; while residing within the implantable neurostimulator 106. The communication subsystem 208 and/or the cipher key exchange subsystem 216, in one embodiment, include a transmitter for sending a cipher key to an external device, and at least one receiver for receiving a cipher key from the external device and for receiving an authorization request from the external device. The cipher key exchange subsystem 216 further includes a cipher key transmittal instruction generator (not shown) that generates a cipher key transmittal instruction. The cipher key transmittal instruction instructs a cipher key to be transmitted to the programmer 120.

In various embodiments, the cipher key exchange subsystem 216 optionally includes the following components (not shown in FIG. 4 which displays the communication subsystem 208 comprising the cipher key exchange subsystem 216): a cipher key selector; a cipher key generator; a cipher key exchange requester; and a memory store. The cipher key selector is configured for selecting a cipher key from a set of cipher keys stored in the memory store at the implantable neurostimulator 106. The cipher key generator is configured for generating a cipher key. The cipher key exchange requester is configured for making one or more requests, according to a set of initiation instructions (described below), for one or more cipher key exchanges between the implantable neurostimulator 106 and the external device.

In embodiments, the external device includes a transmitter for sending an authorization request to the implantable neurostimulator 106, and a receiver for receiving the cipher key from the implantable neurostimulator 106. In various embodiments, the external device optionally includes a memory store.

Typically, the communication subsystem 208 includes a telemetry antenna (which may be situated inside or outside of the housing 104 of the implantable neurostimulator 106), which enables the transmission and reception of signals, to and/or from an external device, via inductive coupling. One external device may comprise a programmer 120 that is used by a clinician to optimize the performance of the implantable neurostimulator 106 for the particular patient, in part, by setting the values of the parameters (e.g., instructions for refreshing a cipher key exchange) that are used by the implantable neurostimulator 106 to control the delivery of therapy and the response of the implantable neurostimulator 106 to the presence of a magnetic field.

Alternative embodiments of the communication subsystem 208 may use an antenna for an RF link or an audio transducer for an audio link to the patient 124, in order to provide indications of neurological events, a system's status, and/or other relevant information.

In a responsive neurostimulator, the control module 108 also may include a detection subsystem 202, which operates on signals corresponding to data sensed from the patient 124 and routed from the electrodes 118 through the electrode interface 200. (The electrode interface 200 may act as a switch to select which electrodes 118 to sense physiological data from and may encompass other functions such as signal conditioning and processing including amplification and isolation).

The detection subsystem 202 may include an EEG analyzer function. The EEG analyzer function may be adapted to receive EEG signals from the electrode 118, through the electrode interface 200, and to process those EEG signals to identify neurological activity indicative of a seizure, an onset of a seizure, and/or a precursor to a seizure.

The detection subsystem 202 also may contain further sensing and detection capabilities, including but not limited to, parameters derived from other physiological conditions (such as electrophysiological parameters, temperature, blood pressure, movement, etc.).

The detection subsystem 202 is coupled with both the central processing unit 210 and the memory subsystem 204 so that data representative of sensed EEG signals can be recorded and stored.

It should be noted that while the memory subsystem 204 is illustrated in FIG. 4 as a separate functional subsystem, the other subsystems might also use various amounts of memory to perform the functions described herein, as well as other functions. The memory subsystem 204 may contain volatile and non-volatile types of memory. Further, while the control module 108 may be a single physical unit contained within a single physical enclosure, namely the housing 104, this does not need to be the case and the control module 108 may be configured differently. The control module 108 may be provided as an external unit not adapted for implantation, or it may include a plurality of spatially separate units, each performing a subset of the capabilities described above. Also, it should be noted that the various functions and capabilities of the subsystems of the neurostimulator 106, including the communications subsystem 208 and its cipher key exchange subsystem 216, may be performed by electronic hardware (e.g., hard wired modules), computer software (or firmware), or a combination thereof. The division of work between the central processing unit 210 and other functional subsystems may also vary. The functional distinctions illustrated in FIG. 4 may not reflect the integration of functions in a real-world system or method according to the embodiments disclosed herein.

In one embodiment, the implantable neurostimulator 106 is provided with magnet sensor 130, such as a giant magnetoresistance or “GMR” sensor, that is configured to generate a signal that is a function of whether the magnet sensor 130 senses the presence of a magnetic field. The signal generated by the magnet sensor 130 may be processed or conditioned using techniques well known in the art such as debouncing, before it is used to control the behavior of the implantable neurostimulator 106.

The patient 124 is provided with a magnet, for example, the donut-shaped magnet 220 shown in FIGS. 2 and 3, which produces a magnetic field strong enough to be recognized by the magnet sensor 130 when the magnet 220 is brought into close enough proximity to the implantable neurostimulator 106. Implementations of magnet sensors other than those implementations using a GMR sensor will be apparent, such as reed switches and the like.

As will be discussed below, embodiments provide a method for securely exchanging cipher keys.

### Example Method for Securely Exchanging Cipher Keys Between an Implantable Device and an External Device

Embodiments provide a method for securely exchanging cipher keys between an implantable device (e.g., implantable neurostimulator) and a device (e.g., programmer) external to and communicatively coupled with the implantable device. More specifically, embodiments provide a method of verifying that an implantable neurostimulator and a programmer are securely exchanging cipher keys using a programmed key stored in the implantable neurostimulator, wherein this method does not require the use of short-range telemetry or an alternative communication channel. Embodiments do not require that the external device requiring a priori knowledge of a cipher key for each implantable neurostimulator. Embodiments also enable a low overhead key-exchange protocol that does not require exhaustive computational resources from the implantable neurostimulator. Further, embodiments provide for a method of facilitating the use of well-known encryption standards as the form of encryption

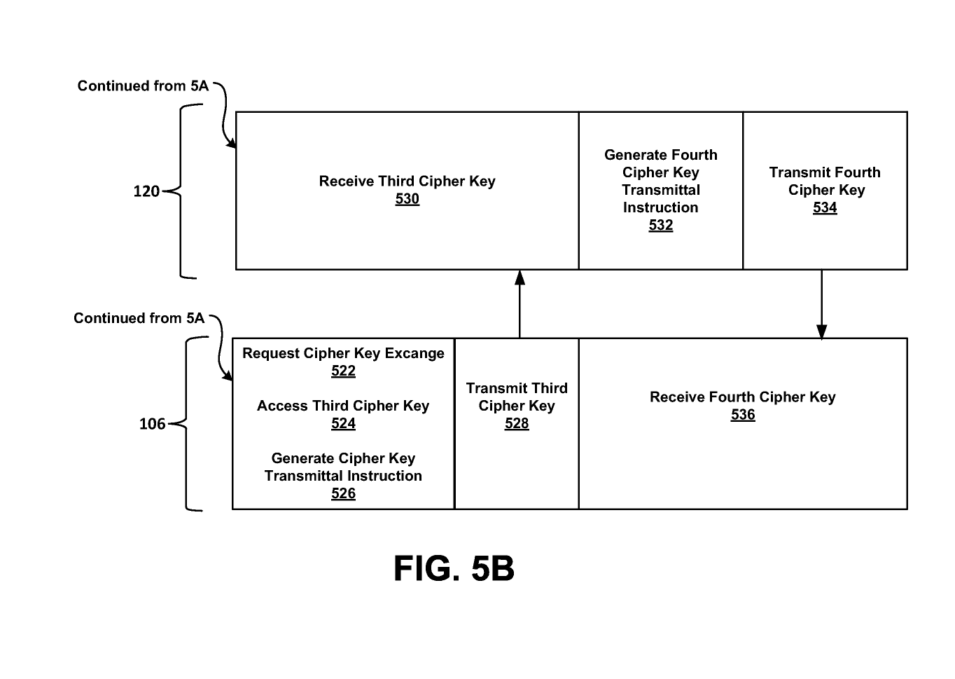

Referring to FIG. 5A and FIG. 5B, a sequence of events corresponding to the behavior of an implantable device (the implantable neurostimulator 106 of FIGS. 1 and 4) and an external device (the programmer 120 of FIGS. 1 and 4) relative to the receipt (by the implantable neurostimulator 106) of an authorization request and the presence of an external magnetic field, such as is provided by the magnet 220 (FIG. 2), and will now be described. In sum, FIG. 5A and FIG. 5B reflect what the implantable device and the external device do in order for a secure exchange of cipher keys to occur between the implantable device and the external device.

In one instance, a clinician wishes to interrogate the implantable device using the external device. However, the clinician must first establish a secure channel (tamper free channel) for the transfer of information between the implantable device and the external device. In one embodiment, the clinician instructs (via the user interface of the external device) the external device to request authorization from the implantable device for interrogation. The authorization request is a request to receive a cipher key of a cipher key exchange. As noted above, in one embodiment the exchange of cipher keys only happens when the external device tries to interrogate an implantable device that it has not previously interrogated. In another embodiment, the exchange of cipher keys happens once a certain time period or time periods has elapsed, in which that time period(s) is preprogrammed into the implantable device. Additionally, according to embodiments and as will be demonstrated, the external device does not need to have a priori knowledge of a cipher key in order to participate in a cipher key exchange.

Referring still to FIG. 5A and FIG. 5B, after the clinician instructs the external device to cause a request for authorization to be transmitted to the implantable device, the external device receives the clinician's request and generates 502 an authorization request transmittal instruction. This authorization request transmittal instruction instructs an authorization request to be transmitted to the implantable device. A portion (e.g., transmitter) of the external device that is capable of communication with the implantable device then transmits 504 the authorization request to the implantable device. The implantable device then receives 506 this authorization request.

Additionally, the implantable device receives 508 an indication that a magnet (e.g., magnet 220) is detected relative to the implantable device. This indication signifies that the environment is secure for communication between the implantable device and the external device. In one embodiment, a magnet sensor (e.g., magnet sensor 130) detects a magnetic field and therefore a presence of the magnet.

After the implantable device receives 506 the authorization request and receives 508 the indication of a detected magnet, the implantable device generates 510 a first cipher key transmittal instruction. The first cipher key transmittal instruction is an instruction for the implantable device to transmit a first cipher key to the external device. In one embodiment, the first cipher key is selected from a set of cipher keys stored in the memory (e.g., memory subsystem 204) of the implantable device. In another embodiment, the implantable device generates the first cipher key. Once the first cipher key is generated, it also may be stored in the memory of the implantable device.

After accessing the first cipher key at the memory of the implantable device, the implantable device transmits 512 the first cipher key to the external device, as per the first cipher key transmittal instruction. The external device then receives 514 the first cipher key.

After receiving the first cipher key, the external device generates 516 the second cipher key transmittal instruction. The second cipher key transmittal instruction instructs the second cipher key to be transmitted to the implantable device. In response to the instruction to transmit the second cipher key, the external device transmits 518 the second cipher key to the implantable device. The implantable device receives 520 the second cipher key. Of note, in one embodiment, the first cipher key and the second cipher key are identical.

Thus, by receiving the authorization request from the external device and receiving an indication of a magnet in the proximity of the implant site of the implantable device, the implantable device is able to determine that a channel is secure. The communication channel is considered to be secured for at least the reason that the patient (e.g., patient 124) with the implantable device has knowledge of the clinician placing the magnet in close proximity to the implantable device. Through the patient's acquiescence to the clinician's swiping of the magnet, it is assumed that the patient is authorizing the determination and establishment of the secure channel. Once the first cipher key exchange has occurred, including the exchange of the first and second cipher key, then the external device may interrogate the implantable device.

In embodiments, the process of exchanging cipher keys may optionally be performed only once, more than once, or repeatedly. For example, the implantable device may be preprogrammed to initiate a cipher key exchange with the external device after an event has occurred, such as an elapsed period of time. For example, the implantable device may be preprogrammed to initiate a cipher key exchange every ten minutes that the external device is in communication with the implantable device. In another example, the implantable device may be preprogrammed to initiate a cipher key exchange after a period of three months has elapsed and upon the receipt of an authorization request. In yet another example, the implantable device may be preprogrammed to initiate a cipher key exchange upon a specified number of interrogations having occurred. For example, when the external device attempts to interrogate the implantable device for the sixth time, the implantable device may then initiate a new cipher key exchange with the external device according to instructions to initiate when the number of interrogations exceeds five.

Thus, and still referring to FIG. 5A and FIG. 5B, based on a set of initiation instructions, the implantable device requests 522 one or more cipher key exchanges between the implantable device and the external programmer. The set of initiation instructions includes an instruction to initiate a request for a cipher key exchange of the one or more cipher key exchanges after a predetermined time period has elapsed since a delivery of a cipher key has occurred. In response to this cipher key exchange initiation, a component within the implantable device accesses 524 a third cipher key. In various embodiments, the third cipher key may be accessed at the memory (e.g., memory subsystem 204) or other memory component of the implantable device. Additionally, the implantable device may generate the third cipher key. This third cipher key, in one embodiment, may also be stored at the memory of the implantable device. Of note, the third cipher key is accessed and/or generated in the same manner in which the first cipher key is accessed and/or generated. The implantable device then generates 526 a third cipher key transmittal instruction, which instructs the third cipher key to be transmitted to the external device.

The implantable device then transmits 528 the third cipher key according to the third cipher key transmittal instruction. The external device receives 530 the third cipher key.

After receiving the third cipher key, the external device generates 532 a fourth cipher key transmittal instruction. The fourth cipher key transmittal instruction instructs the fourth cipher key to be transmitted to the implantable device. In response to the instruction to transmit the fourth cipher key, the external device transmits 534 the fourth cipher key to the implantable device. The implantable device receives 536 the fourth cipher key.

Of note and as discussed herein, the cipher key exchange may occur repeatedly (two or more times), based on initiation instructions. Therefore, it should be understood that with regard to the third or a higher number of cipher key exchange occurring according to the initiation instructions, the cipher keys that are generated and exchanged are considered to be the “third cipher key” and the “fourth cipher key”. For example, in an embodiment, a refresh of a cipher key exchange is requested, based on cipher key exchange initiation instructions. In one embodiment, a refresh of the cipher key exchange is between the implantable device and the external device after a predetermined time period has elapsed since a delivery of the first cipher key. The refresh of the cipher key exchange includes a delivery by the implantable device of the third cipher key and the receipt by the implantable device of the fourth cipher key. The third cipher key is sent and received in the same manner as the first cipher key is sent and received. The fourth cipher key is sent and received in the same manner as the second cipher key is sent and received. Once the third cipher key and the fourth cipher key are sent and received, then a refreshed cipher key exchange has occurred. In one embodiment, the third cipher key and the fourth cipher key are identical. The predetermined time period that has elapsed since a delivery of the first cipher key or the occurrence of a cipher key exchange may be any period of time that is programmed into the implantable device. For example, the implantable device may be programmed to initiate a cipher key exchange after 24 hours has elapsed since the last cipher key exchange. The time is tracked (e.g., via the clock supply 212) that has elapsed since the last cipher key exchange. Once this predetermined time has been found to elapsed, a refresh of the cipher key exchange is initiated. The external device receives the third cipher key via the external device cipher key receiver 522 and then sends the fourth cipher key 540 via the external device cipher key sender 524. Thus, embodiments provide for the occurrence of two or more cipher key exchanges between the same implantable device and external device.

Of further note, it should be appreciated that the implantable device discussed herein, in various embodiments, is an implantable medical device. Further, the implantable medical device, in various embodiments, is the implantable neurostimulator 106. It should also be appreciated that the external device discussed herein, in various embodiments, is the programmer 120 or the patient monitor 126. Moreover, embodiments may be integrated within all sorts of active medical implantable devices, including but not limited to the following: implantable medical devices delivering treatment in the form of drug delivery, optical energy, and mechanical energy; and implantable medical devices that may be controlled with means such as mechanical pressure or electrical fields.

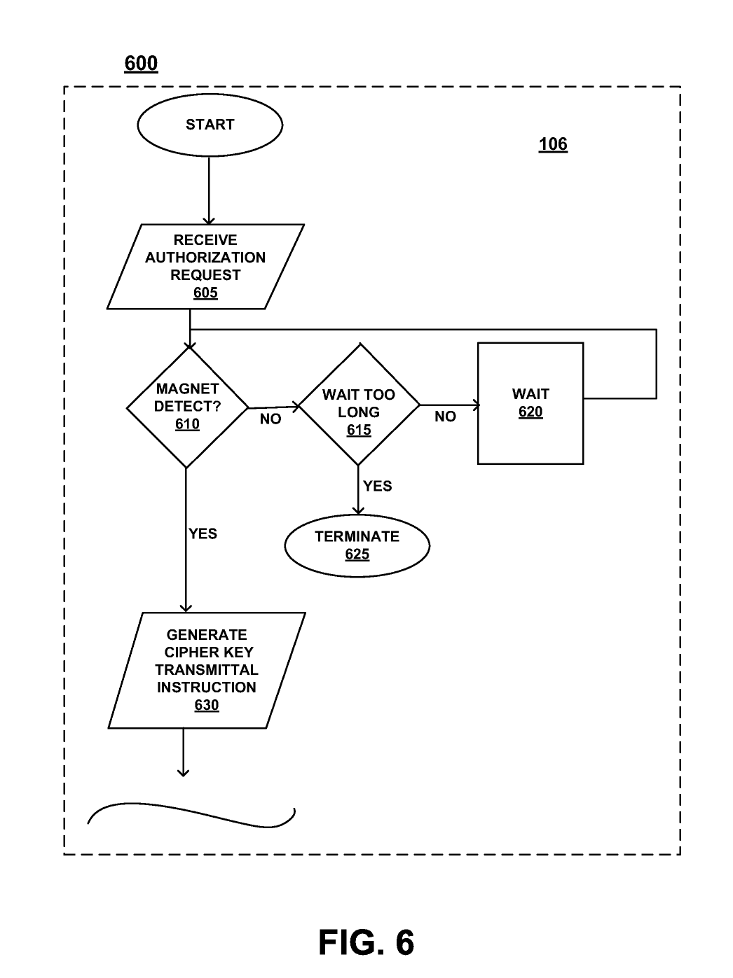

FIG. 6 is a flow diagram of elements of a method 600 for securely exchanging cipher keys between an implantable device and an external device, in accordance with an embodiment. With reference now to FIG. 4 and FIG. 6, an implantable neurostimulator 106 includes a communication subsystem 208 which enables communication between the implantable neurostimulator 106 (when implanted in a patient) and the outside world. The communication system 208 includes a magnet sensor 130 (for example, provided on a printed circuit board within a neurostimulator housing 104 or otherwise associated with a control module 108 of the implantable neurostimulator 106b). The magnet sensor 130 generates an output signal when the magnet sensor 130 detects the presence of a magnetic field, such as from the magnet 220. The magnet sensor output is processed and used by a cipher key exchange subsystem 216 to determine if a first cipher key transmittal instruction is to be generated.

In FIG. 6 at block 605, the method and system receives the authorization request from the external device. At block 610, a magnet sensor (e.g., magnet sensor 130) determines if a magnet is detected, as is described above. If a magnet is not detected, methods and systems continue to wait for an indication of a detected magnet for a predetermined period of time (e.g., preprogrammed into embodiments of the system). If the predetermined period of time elapses without receiving an indication that a magnet is detected in the proximity of the implantable device, then the operation is terminated, shown at block 625. However, if the system does not contain a preprogrammed period of time at which the presence of a magnet must be detected, then the system continues to wait, shown at block 620, until the magnet's presence is detected. If a magnet is detected, then the system and method, shown at block 630, generates the cipher key transmittal instruction.

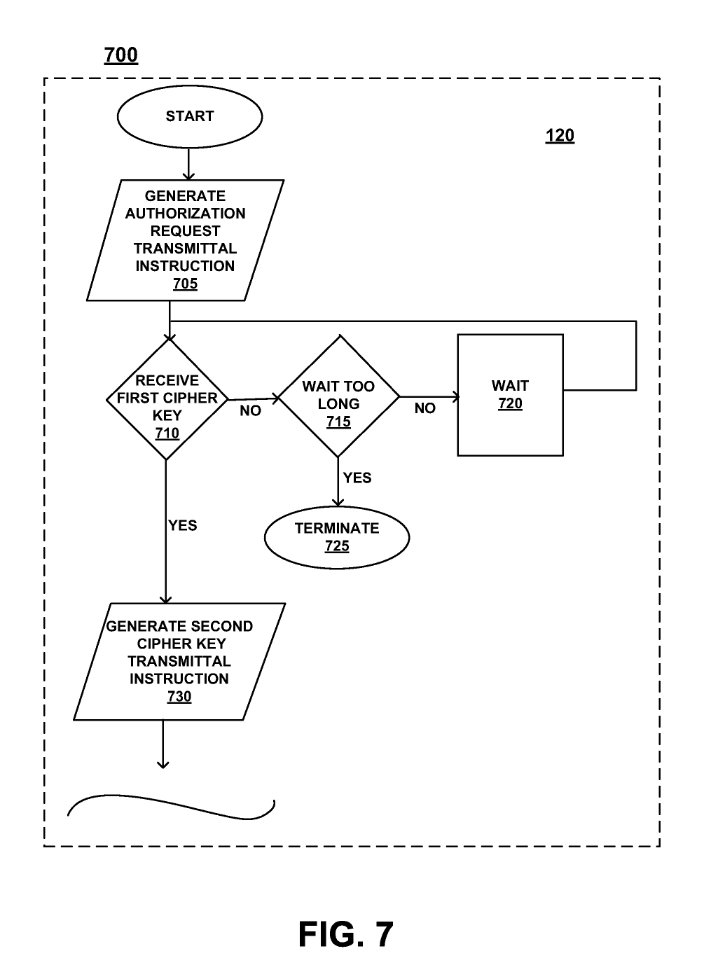

FIG. 7 is a flow diagram of elements of a method 700 for securely exchanging cipher keys between an implantable device and an external device, in accordance with an embodiment. With reference now to FIG. 1, FIG. 5A, FIG. 5B, and FIG. 7, an external device, according to embodiments, is configured for communicating with the implantable device, as is described with reference to the programmer 120 and/or the patient remote monitor 126. At block 605, the method and system generates the authorization request transmittal instruction. At block 710, it is determined if the external device has received the first cipher key that was sent to it by the implantable device. At block 715, if the system of the external device is waiting for a period that exceeds a preprogrammed wait time (for the receipt of the first cipher key), then the operation is terminated, shown at block 725. However, if there is no preprogrammed wait time for the receipt of the first cipher key, then, at block 720, the system of the external device continues to wait for the receipt of the first cipher key. If the first cipher key is received, then, at block 730, the system generates the second cipher key transmittal instruction.

Example embodiments for securely exchanging cipher keys between an implantable neurostimulator and a programmer are thus described. While the present technology has been described in particular examples, it should be appreciated that the present technology should not be construed as limited by such examples, but rather construed according to the claims.

With regard to the flow diagrams of FIG. 6 and FIG. 7, it should be noted that there can be a variety of ways these processes are implemented. For example, software, hardware (including ASICs, FPGAs, and other custom electronics), and various combinations of software and hardware, are all solutions that would be possible to practitioners of ordinary skill in the art of electronics and systems design. It should further be noted that the steps described herein as performed in software need not be, as some of them can be implemented in hardware, if desired, to further reduce computational load on the processor. In various embodiments, the methods 600 and 700, described above, are carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of non-transitory computer readable storage medium.

All statements herein reciting principles, aspects, and embodiments of the technology as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present technology, therefore, is not intended to be limited to the embodiments shown and described herein. Rather, the scope and spirit of present technology is embodied by the appended claims.

What we claim is:

1. A system for securely exchanging cipher keys between an implantable device and an external device, the system includes:
an implantable device communicatively coupled with an external device, wherein the implantable device comprises a cipher key exchange subsystem configured for:
receiving an indication that a magnet is detected relative to the implantable device;
receiving an authorization request from the external device, wherein the authorization request is a request to receive a first cipher key of a cipher key exchange; and
based on receiving the indication that the magnet is detected and receiving the authorization request from the external device, generating a first cipher key transmittal instruction, wherein the first cipher key transmittal instruction instructs the first cipher key to be transmitted to the external device by the implantable device, and
wherein the external device is configured for:
transmitting the authorization request to the implantable device; and
receiving the first cipher key from the implantable device.

2. The system of claim 1, wherein the cipher key exchange subsystem is further configured for selecting the first cipher key from a set of cipher keys stored in a memory at the implantable device.

3. The system of claim 1, wherein the cipher key exchange subsystem is further configured for generating the first cipher key.

4. The system of claim 1, wherein the cipher key exchange subsystem is further configured for receiving a second cipher key from the external device.

5. The system of claim 1, wherein the cipher key exchange subsystem is further configured for making one or more requests, according to a set of initiation instructions, for one or more cipher key exchanges between the implantable device and the external device.

6. The system of claim 5, wherein the set of initiation instructions includes:
at least one instruction to initiate a request for a cipher key exchange of the one or more cipher key exchanges after a predetermined time period has elapsed since a delivery of a cipher key to the external device has occurred.

7. The system of claim 6, wherein the cipher key is one of any cipher key that is delivered to the external device subsequent to the delivery of the first cipher key.

8. The system of claim 1, wherein the external device is further configured for transmitting a second cipher key to the implantable device.

9. The system of claim 1, wherein the external device is further configured for storing at least one received cipher key in a memory.

10. The system of claim 1, wherein the implantable device includes:
an implantable medical device.

11. A non-transitory computer readable storage medium having stored thereon, computer-executable instructions that, when executed by a computer, cause the computer to perform a method for securely exchanging cipher keys between an implantable device and an external device, the method includes:
receiving an authorization request from the external device, wherein the authorization request is a request to receive a first cipher key of a cipher key exchange;
receiving an indication that a magnet is detected relative to the implantable device, wherein the indication signifies a secure environment for communication between the implantable device and the external device; and
after receiving the authorization request and the indication of a detected magnet, generating a first cipher key transmittal instruction, wherein the first cipher key transmittal instruction instructs the first cipher key to be transmitted to the external device by the implantable device.

12. The non-transitory computer readable storage medium of claim 11, wherein the method further includes:
selecting the first cipher key from a set of cipher keys stored in a memory of the implantable device.

13. The non-transitory computer readable storage medium of claim 11, wherein the method further includes:
generating the first cipher key.

14. The non-transitory computer readable storage medium of claim 11, wherein the method further includes:
after the first cipher key has been transmitted to the external device, receiving a second cipher key from the external device.

15. The non-transitory computer readable storage medium of claim 11, wherein the method further includes:
based on a set of initiation instructions, requesting one or more cipher key exchanges between the implantable device and the external device, wherein the set of initiation instructions includes an instruction to initiate a request for a cipher key exchange of the one or more cipher key exchanges after a predetermined time period has elapsed since a delivery of a cipher key has occurred;
accessing a third cipher key; and
generating a third cipher key transmittal instruction, wherein the third cipher key transmittal instruction instructs the third cipher key to be transmitted to the external device.

16. The non-transitory computer readable storage medium of claim 15, wherein the accessing a third cipher key includes:
accessing the third cipher key from a set of cipher keys stored in a memory.

17. The non-transitory computer readable storage medium of claim 15, wherein the method further includes:
in response to requesting one or more cipher key exchanges, generating the third cipher key.

18. A system for securely exchanging cipher keys between an implantable device and an external device, the system includes:
an implantable device communicatively coupled with an external device, wherein the implantable is configured for:
receiving an indication that a magnet is detected relative to the implantable device;
receiving an authorization request from the external device, wherein the authorization request is a request to receive a first cipher key of a cipher key exchange; and
based on receiving the indication that the magnet is detected and receiving the authorization request from the external device, transmitting a first cipher key to the external device, and
wherein the external device is configured for:
transmitting the authorization request to the implantable device; and
receiving the first cipher key from the implantable device.

19. The system of claim 18, wherein the external device is further configured for:
in response to receiving the first cipher key from the implantable device, generating a second cipher key; and
transmitting the second cipher key to the implantable device.

20. The system of claim 18, wherein the implantable device is further configured for:
receiving the second cipher key from the external device; and after receiving the authorization request and the indication of a detected magnet, generating a first cipher key transmittal instruction, wherein the first cipher key transmittal instruction instructs the first cipher key to be transmitted to the external device by the implantable device.
